(19) United States
(12) Patent Application Publication
(10) Pub. No.: US 2003/0045265 A1
(43) Pub. Date: Mar. 6, 2003

(54) Audio system with automatic mute control triggered by wireless communication of mobile phones

(76) Inventors: Shih-Sheng Huang, Taipei Hsien (TW); Jong-Ding Wang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,367

(22) Filed: Jul. 7, 2002

(30) Foreign Application Priority Data
Aug. 30, 2001 (TW) 090121529

(51) Int. Cl. H04B 1/06

(52) U.S. Cl. 455/355; 455/345; 455/70; 455/219

(57) ABSTRACT

An audio system has a playing circuit for generating an audio signal, at least a speaker electrically connected to the playing circuit for playing sound according to the audio signal, a detector for detecting a communication signal of mobile phones or automobile phones and generating a corresponding mute signal, and a mute circuit electrically connected to the detector and the playing circuit for receiving the mute signal. The mute circuit stops the speaker from playing sound after the mute circuit receives the mute signal.

### BACKGROUND OF INVENTION

1. Field of the Invention

The present invention relates to an audio system and a related automatic mute device, and more particularly, to an audio system with automatic mute control triggered by wireless communication of mobile phones.

2. Description of the Prior Art

As wireless mobile communication develops day-by-day, mobile phones (cellular phones) are becoming increasingly popular. Wireless communication can be used to communicate with someone, exchange opinions, and transmit information or knowledge. Particularly, drivers can use wireless automobile phones or mobile phones to communicate conveniently when they are driving. Users can communicate without being limited by a location of a telephone line.

Although it is dangerous to use mobile phones when driving, a hands-free mobile phone developed for the automobile phone substantially decreases danger. However, drivers always like to listen to broadcasts when driving in order to enjoy music or listen to roadway situations. If a telephone call is received on the mobile phone when the driver is driving, the driver must turn off the music or reduce the volume. If not, the driver is distracted by the music of the broadcast when using the mobile phone or automobile phone to communicate with someone. When the above situation arises, an accident can easily occur since drivers are distracted from driving.

### SUMMARY OF INVENTION

It is therefore a primary objective of the claimed invention to provide an audio system (especially automobile audio systems) with automatic mute control triggered by wireless communication of mobile phones, so as to solve problems of the prior art audio system.

The claimed invention, briefly summarized, discloses an audio system and a related automatic mute device. The audio system includes a playing circuit for generating an audio signal, at least a speaker electrically connected to the playing circuit for playing sound according to the audio signal, a detector for detecting a communication signal of mobile phones or automobile phones and generating a corresponding mute signal, and a mute circuit electrically connected to the detector and the playing circuit for receiving the mute signal. The mute circuit stops the speaker from playing sound after the mute circuit receives the mute signal.

It is an advantage of the claimed invention that the claimed invention audio system with automatic mute function can prevent drivers from being distracted by sounds of the audio system in order to prevent accidents. The claimed invention helps to promote safe driving while using mobile communication.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a functional block diagram of a present invention audio system.

FIG. 2 is a perspective view of the present invention signal waves, in which the signal waves of the operating process change with time.

### DETAILED DESCRIPTION

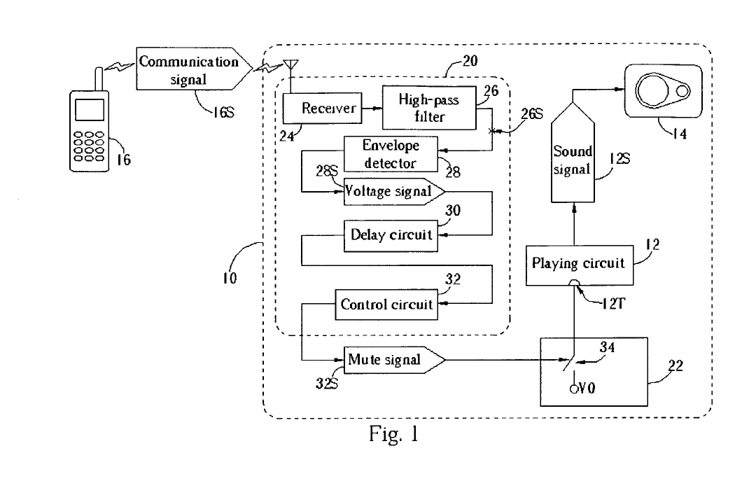

Please refer to FIG. 1. FIG. 1 is a functional block diagram of a present invention audio system 10. The automobile audio system is used as an example in this embodiment. The automobile audio system is installed in a car so that drivers and passengers can enjoy music or listen to broadcasts when the car is running. The audio system 10 comprises a playing circuit 12 and a speaker 14 for playing sounds. The playing circuit 12 can be a CD player, a radio, or a tape player, etc, for generating audio signals 12S. The speaker 14 can be a general amplifier or an earphone, for vibrating sound waves so as to generate sounds. When the audio system 10 is playing sounds, the playing circuit 12 transmits the audio signals 12S to the speaker 14. Then the speaker 14 transforms the audio signals 12S into sound waves so that users can listen to the sounds.

As mentioned above, the important point of the present invention technology is that the audio system 10 can automatically stop playing sounds when users use mobile phones to communicate with someone, so that users are not distracted by sounds of the audio system. In order to achieve this purpose, the present invention audio system 10 further comprises a detector 20 and a mute circuit 22. The detector 20 is used to detect communication signals of the mobile phone or the automobile phone. The mute circuit 22 is used to control the playing circuit 12 to stop playing sounds according to the detecting result of the detector 20. In general, modern audio systems, especially automobile audio systems, have a mute control end installed in the playing circuit. The playing circuit enters a mute situation only if the mute control end is connected to a suitable voltage signal (such as ground) so that the audio system stops playing sounds. If this playing circuit is used in the present invention, the mute circuit can electrically connect to the mute control end of the playing circuit directly so as to control the playing circuit to stop playing the sounds. As shown in FIG. 1, the playing circuit 12 has a mute control end 12T. The mute circuit 22 is electrically connected to the mute control end 12T.

In order to detect the communication signals of the wireless mobile communication, the detector 20 further comprises a receiver 24, a high-pass filter 26, an envelope detector 28, a delay circuit 30, and a control circuit 32. The mute circuit 22 includes a switch circuit 34 controlled by the control circuit 32. The switch circuit 34 is used to control the mute control end of the playing circuit 12 to connect or not connect to the voltage signal V0, which causes the playing circuit 12 to stop playing sounds. The receiver 24 is used to receive the radio wave signals and transform the radio wave signals into corresponding electrical signals. The communication signals used in mobile communication are radio wave signals. Therefore, the receiver 24 can receive the communication signals of the mobile communication. The high-pass filter 26 is electrically connected to the receiver 24 for filtering low frequency signals received by the receiver 24. Since the wireless wave signals may be mixed with the low frequency broadcast signals (such as signals of a frequency modulation) or other mixed signals, and these low frequency signals are not the communication signals of the wireless mobile communication, these low frequency signals are filtered by the high-pass filter 26. A pass-band of the high-pass filter 26 is over 900 MHz in the present embodiment so as to match signal characteristics of wireless mobile communication characteristics. Most of the wireless frequency bands used in the modern wireless communications are 900 MHz or 1800 MHz. The envelope detector 28 is electrically connected to the high-pass filter 26 for transforming the high frequency signals outputted from the high-pass filter 26 into signal voltages (envelope). The envelope detector 28 further filters the signal voltage, which is lower than a predetermined voltage (called a reference voltage in the following), so as to avoid interference by the mixed signals. The delay circuit 30 is electrically connected to the envelope detector 28 for delaying the signal outputted from the envelope detector 28 for a predetermined delay time so as to determine the real communication signals of the mobile phone. The mobile phone emits a short pulse wave to respond to a wireless mobile communication station in each predetermined time. However, these short pulse waves are not real communication signals that users of the mobile phone use to communicate with someone. Therefore, these short pulse waves are filtered by the delay circuit 30. At last, the control circuit 32 electrically connected to the delay circuit 30 generates a corresponding mute signal 32S according to the output of the delay circuit 30. The mute signal 32S controls the switch circuit 34 inside the mute circuit 22. The mute signal 32S decides whether the mute control end 12T of the playing circuit 12 should connected to the voltage signal V0 or not. Once the mute control end 12T is electrically connected to the voltage signal V0 through the switch circuit 34, the playing circuit 12 makes the audio system 10 enter the mute situation in order to stop playing sounds.

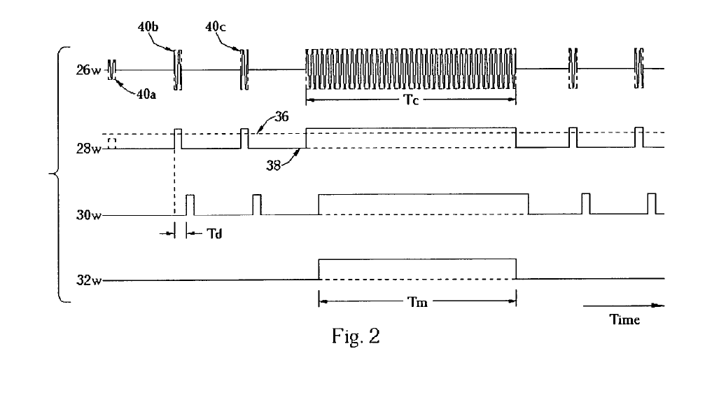

Please refer to FIG. 2 along with FIG. 1. FIG. 2 is a perspective view of the present invention signal waves in which the signal waves of the operating process change with time. The horizontal axis of FIG. 2 represents times. The waves 26w, 28w, 30w, and 32w arranged from top to bottom in FIG. 2 respectively represent the waves of node 26S (shown in FIG. 1), the voltage signal 28S, and the delay signals and the mute signals 32S of the delay circuit 30. The operating process of the present invention is illustrated as follows. The present invention receiver 24 receives the radio wave signals any time. The high-pass filter 26 filters the lower frequency signals received by the receiver 24 so as to obtain signals inside the frequency band of the wireless mobile communication. The wave 26w shown in FIG. 2 is a signal wave, which is filtered by the high-pass filter 26 and then outputted at node 26S. Short pulse waves such as 40a, 40b, 40c, etc, are signals that the mobile phone automatically uses to respond to the wireless mobile communication station. The mobile phone 16 emits communication signals 16S when users use mobile phone 16 (shown in FIG. 1) to communicate with someone in time period Tc (shown in FIG. 2). In this embodiment, users may be the driver or passengers inside the car, and the audio system 10 is the automobile audio system installed inside the car. Therefore, the mobile phones 16 of users are in close proximity to the receiver 24. The communication signals 165 show a continuous high-power, high-voltage wave on the wave 26w during time period Tc shown in FIG. 2.

After receiving the signals outputted from the high-pass filter 26 at node 26S, the envelope detector 28 transforms the signals outputted from the high-pass filter 26 into voltage signals 28S, as wave 28w shows in FIG. 2. In order to avoid interference caused by other signals (such as mixed high frequency signals, or other communication signals and short pulse signals which are not emitted by the mobile phone 16), the envelope detector 28 filters the voltage signals (in the wave 28w) that are lower than a reference voltage. The signal voltage 36 shown in FIG. 2, marked by a horizontal dashed line, represents the reference voltage (another signal voltage 38 represents 0 volts). Please notice that the lower voltage signals in wave 28w corresponding to the short pulse wave 40a are filtered by the envelope detector 28 since the signal voltage of the short pulse wave 40a are lower than the reference voltage.

In order to further remove the short pulse waves (signals which mobile phones automatically emit to respond to the wireless mobile communication station), which are not the normal communication signals 16S inside the voltage signal 28S, the delay circuit 30 delays the voltage signal 28S for a predetermined delay time Td, as shown in wave 30w of FIG. 2. The delay circuit 30 compares wave 30w with the original wave 28w. If the signals continuously maintain high voltages after the delay time Td, the delay circuit 30 determines the signals are the normal communication signals. Otherwise, the signals that do not maintain high voltages after the delay time Td are filtered by the delay circuit 30. Since the delay time Td is longer than the duration time of the short pulse wave, the short pulse wave in the wave 28w is not present after delay time Td. Therefore, the delay circuit 30 filters the short pulse waves inside the voltage signals 28S, and keeps the real communication signals which are used by the mobile phone 16 to communicate with someone. After the delay circuit 30 has filtered the short pulse waves, the control circuit 32 emits the corresponding mute signal 32S according to the output of the delay circuit 30, as shown in wave 32w of FIG. 2. The high voltage of the wave 32w in the time period Tm corresponds to the wireless mobile communication in which users use the mobile phone 16 to communicate with someone in time period Tc. The high voltage signal of the mute signal 32S makes the switch circuit 34 inside the mute circuit 22 connect the mute control end 12T to to the voltage signal V0. Therefore, the playing circuit 12 makes the audio system 10 stop playing sounds, achieving the purpose of the present invention. Please notice that when users stop using the mobile phone 16 to communicate with someone after time period Tc, the mute signal 32S returns to a lower voltage as shown in wave 32w of FIG. 2. Then, the switch circuit 34 disconnects the mute control end 12T from the voltage signal V0. Therefore, the playing circuit 12 enables the audio system 10 to play sounds again, but without the need for any operation by the users.

In practice, the detector 20 and the mute circuit 22 of the present invention can be made inside a same circuit block (such as a chip or a circuit card) so as to form a single automatic mute device. The circuit structure of the present invention can be quickly achieved by electrically connecting the automatic mute device to the mute control end 12T of the playing circuit 12 and the suitable voltage signal V0, achieving the function of the present invention. This is especially true for modern automobile audio systems, which have provided the mute control end in an external terminal manner. Users just externally connect the present invention automatic mute device to the mute control end so as to simply and quickly accomplish the framework of the present invention, achieving the automatic mute function of the present invention.

As mentioned above, the purpose of the present invention is to make the audio system automatically mute when users use mobile phone or automobile phone to communicate with someone. The present invention high-pass filter 26 filter signals which are lower than the frequency band (it is 900 MHz or 1800 MHz in general) of the mobile communication. However, the present invention can be further used in wireless peripherals. When users use the wireless peripheral, the present invention can make the audio system mute according to the wireless wave signals of the wireless peripheral. In the present industry standard, bluetooth standard institutes a frequency band (called bluetooth frequency band in the following) of 2500 MHz (2.5 GHz) for controlling the wireless peripherals. For example, modern mobile phones or automobile phones always come equipped with a wireless bluetooth earphone. When users use the mobile phone to communicate with someone, the mobile phone sends the communication contents to the wireless bluetooth earphone through radio signals of the bluetooth frequency band. The wireless bluetooth earphone transforms the radio communication contents of the bluetooth frequency band into sound waves so that users can listen to sounds. In this situation, the frequency band of the present invention high-pass filter can be adjusted so as to filter radio waves which are not in the bluetooth frequency band. Therefore, the present invention can be used in bluetooth wireless peripherals. When users use the bluetooth earphone (or other bluetooth peripherals), the present invention can make the audio system stop playing sounds according to the radio wave signals of the bluetooth frequency band so that users can use bluetooth wireless peripheral without interference.

In conclusion, in the present invention, the audio system (the present invention uses the automatic audio system as an example) operates with the detector and the mute circuit so as to make the audio system stop playing sounds when the driver or passengers use mobile phones or automobile phones to communicate with someone. Therefore, driver distraction is reduced considerably. In contrast with the prior art audio system without automatic mute function, the present invention automatic mute function can prevent drivers from being distracted by sounds of the audio system in order to avoid accidents. In addition, the present invention still has several advantages. First, the present invention detects the radio communication signal of mobile phones directly. No matter how many passengers are inside the car, or what kind of mobile phones are being used, the present invention detector also can detect the radio communication signals under the present wireless mobile communication standard. The present invention automatic mute system can be used in all different types and brands of mobile phone. Although there may be a plurality of mobile phones inside one car, if users use at least one of the mobile phones to communicate with someone, the present invention can start the function of making the audio system automatically stop playing sounds. Users do not need to additionally set the audio system, the detector, or the mute circuit. Of course the audio system hardware also does not need to be changed. Furthermore, as mentioned before, the present invention automatic mute system can be directly connected to the playing circuit in an external connection. Therefore, the present invention can be achieved simply and quickly and does not require the redesign of the playing circuit, and the software and hardware of the speaker.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An audio system comprising:
a playing circuit for generating an audio signal;
at least a speaker electrically connected to the playing circuit for playing sound according to the audio signal;
a detector for detecting a communication signal of a mobile phone or an automobile phone and generating a corresponding mute signal; and
a mute circuit electrically connected to the detector and the player circuit for receiving the mute signal;
wherein the mute circuit stops the speaker from playing sound after the mute circuit receives the mute signal.

2. The audio system of claim 1 being an automobile audio system.

3. The audio system of claim 1 wherein the detector generates the mute signal when a signal voltage of the communication signal is larger than a predetermined value so as to make the mute circuit stop the speaker from playing sound.

4. The audio system of claim 1 wherein the detector generates the mute signal when a sustained time of the communication signal is longer than a predetermined time so as to make the mute circuit stop the speaker from playing sound.

5. The audio system of claim 1 wherein the communication signal is a radio communication signal.

6. The audio system of claim 5 wherein a frequency band of the radio communication signal is about 900 MHz.

7. The audio system of claim 5 wherein a frequency band of the radio communication signal is about 1800 MHz.

8. The audio system of claim 5 wherein the detector comprises:
a receiver for receiving the radio communication signal;
a high-pass filter for filtering out low frequency waves of the radio communication signal;
an envelope detector electrically connected to the high-pass filter for measuring the direct current signal voltage of the communication signal and generating a corresponding voltage signal; and
a control circuit for generating the mute signal according to the voltage signal.

9. The audio system of claim 8 wherein the detector further comprises a delay circuit electrically connected between the envelope detector and the control circuit for delaying the voltage signal for a predetermined delay time and generating a corresponding delay signal, and the control circuit generates the mute signal according to the delay signal.

10. The audio system of claim 8 wherein a pass-band of the high-pass filter is over 900 MHz or 2500 MHz.

11. An automatic mute device for an audio system, the audio system comprising:
a playing circuit for generating an audio signal; and
at least a speaker electrically connected to the playing circuit for playing sound according to the audio signal;
the automatic mute device comprising:
a detector for detecting a communication signal of a mobile phone or an automobile phone and generating a corresponding mute signal; and
a mute circuit electrically connected to the detector and the player circuit of the audio system for receiving the mute signal;
wherein the mute circuit stops the speaker from playing sound after the mute circuit receives the mute signal.

12. The automatic mute device of claim 11 wherein the audio system is an automobile audio system.

13. The automatic mute device of claim 11 wherein the detector generates the mute signal when a signal voltage of the communication signal is larger than a predetermined value so as to make the mute circuit stop the speaker from playing sound.

14. The automatic mute device of claim 11 wherein the detector generates the mute signal when a sustained time of the communication signal is longer than a predetermined time so as to make the mute circuit stop the speaker from playing sound.

15. The automatic mute device of claim 11 wherein the communication signal is a radio communication signal.

16. The automatic mute device of claim 15 wherein a frequency band of the radio communication signal is about 900 MHz.

17. The automatic mute device of claim 15 wherein a frequency band of the radio communication signal is about 1800 MHz.

18. The automatic mute device of claim 15 wherein the detector comprises:
a receiver for receiving the radio communication signal;
a high-pass filter for filtering out low frequency waves of the radio communication signal;
an envelope detector electrically connected to the high-pass filter for measuring the direct current signal voltage of the communication signal and generating a corresponding voltage signal; and
a control circuit for generating the mute signal according to the voltage signal.

19. The automatic mute device of claim 18 wherein the detector further comprises a delay circuit electrically connected between the envelope detector and the control circuit for delaying the voltage signal for a predetermined delay time and generating a corresponding delay signal, and the control circuit generates the mute signal according to the delay signal.

20. The automatic mute device of claim 18 wherein a pass-band of the high-pass filter is over 900 MHz or 2500 MHz.
